(19) United States
(12) Patent Application Publication
(10) Pub. No.: US 2020/0145890 A1
(43) Pub. Date: May 7, 2020

(54) CHANNEL SWITCHING METHOD AND APPARATUS, AND COMMUNICATION DEVICE

(71) Applicant: SZ DJI TECHNOLOGY CO., LTD., Shenzhen (CN)

(72) Inventors: Ning MA, Shenzhen (CN); Ying CHEN, Shenzhen (CN)

(21) Appl. No.: 16/734,806

(22) Filed: Jan. 6, 2020

Related U.S. Application Data
(63) Continuation of application No. PCT/CN2017/099561, filed on Aug. 30, 2017.

(51) Int. Cl. H04W 36/06; H04W 36/36; H04W 36/30; H04W 36/20

(52) U.S. Cl. CPC H04W 36/06; H04W 36/20; H04W 36/30; H04W 36/36

(57) ABSTRACT

The present disclosure provides a channel switching method. The channel switching method includes obtaining interference power of multiple channels in a communication frequency band; obtaining interference power of a current channel; when the interference power of the current channel exceeds a preset threshold, selecting a target channel according to the interference power of the multiple channels; and switching to the target channel for communication.

### CROSS-REFERENCE TO RELATED APPLICATION

This application is a continuation of International Application No. PCT/CN2017/099561, filed Aug. 30, 2017, the entire content of which is incorporated herein by reference.

### TECHNICAL FIELD

The present disclosure generally relates to the field of communication technology and, more particularly, relates to a channel switching method and apparatus, and a communication device.

### BACKGROUND

In a wireless communication system, a terminal has to perform a clear channel assessment (CCA) before transmitting data to determine whether a channel is available so as to adaptively avoid interference with other users. The CCA is based on “listen before talk” (LBT). That is, before a terminal needs to send data on a channel, the terminal can monitor and implement the CCA on the channel. When the interference generated by the channel exceeds the LBT threshold, the terminal can enter another channel through a protocol, and monitor and implement the CCA on that channel. When the interference of the channel is not suitable for communication, the terminal needs to continue to try to switch to other channel, which leads to frequent channel switching, and increases data transmission delay.

The disclosed channel switching method and apparatus, and communication device are directed to solve one or more problems set forth above and other problems in the art.

### SUMMARY

One aspect of the present disclosure provides a channel switching method. The channel switching method includes obtaining interference power of multiple channels in a communication frequency band; obtaining interference power of a current channel; when the interference power of the current channel exceeds a preset threshold, selecting a target channel according to the interference power of the multiple channels; and switching to the target channel for communication.

Another aspect of the present disclosure provides a channel switching apparatus. The channel switching apparatus includes a memory, configured to store program code; and a processor, coupled to the memory and when the program code being executed, configured to: obtain interference power of multiple channels in a communication frequency band and obtain interference power of a current channel; select a target channel according to the interference power of the multiple channels when the interference power of the current channel exceeds a preset threshold; and switch to the target channel for communication.

Another aspect of the present disclosure provides a communication device. The communication device includes a transceiver; a memory, configured to store executable program code; and a processor, configured to call the executable program code stored in the memory. The processor, the transceiver, and the memory are connected through a bus. The processor calls the executable program code stored in the memory to implement a channel switching method, including obtaining interference power of multiple channels in a communication frequency band; obtaining interference power of a current channel; when the interference power of the current channel exceeds a preset threshold, selecting a target channel according to the interference power of the multiple channels; and switching to the target channel for communication.

Other aspects of the present disclosure can be understood by those skilled in the art in light of the description, the claims, and the drawings of the present disclosure.

### BRIEF DESCRIPTION OF THE DRAWINGS

In order to more clearly illustrate the technical solutions in the embodiments of the present disclosure, the drawings that need to be used in the description of the embodiments will be briefly described below. It is obvious that the drawings in the following description are some embodiments of the present disclosure, and for those of ordinary skill in the art, other drawings may also be obtained according to these drawings without any creative effort.

FIG. 1 illustrates a schematic flowchart of an exemplary channel switching method according to various embodiments of the present disclosure;

FIG. 2 illustrates a schematic flowchart of another exemplary channel switching method according to various embodiments of the present disclosure;

FIG. 3 illustrates a schematic flowchart of another exemplary channel switching method according to various embodiments of the present disclosure;

FIG. 4 illustrates a schematic block diagram of an exemplary channel switching apparatus according to various embodiments of the present disclosure; and

FIG. 5 illustrates a schematic block diagram of an exemplary communication device according to various embodiments of the present disclosure.

### DETAILED DESCRIPTION OF THE EMBODIMENTS

In the following, the technical solutions in the embodiments of the present disclosure will be clearly described with reference to the accompanying drawings in the embodiments of the present disclosure. It is obvious that the described embodiments are only a part of the embodiments of the present invention, but not all of the embodiments. All other embodiments obtained by those skilled in the art based on the embodiments of the present disclosure without creative efforts are within the scope of the present disclosure.

It should be noted that when a component is referred to as being “fixed” to another component, it can be directly on the other component or an intermediate component may be present. When a component is considered as “connected to” another component, it can be directly connected to another component or both may be connected to an intermediate component.

All technical and scientific terms used herein have the same meaning as commonly understood by one of ordinary skill in the art to which this disclosure belongs, unless otherwise defined. The terminology used in the description of the present disclosure is for the purpose of describing particular embodiments and is not intended to limit the disclosure. The term “and/or” used herein includes any and all combinations of one or more of the associated listed items.

Some embodiments of the present disclosure are described in detail below with reference to the accompanying drawings. The features of the embodiments and examples described below can be combined with each other without conflict.

The embodiments of the present disclosure provide a channel switching method, a channel switching apparatus, and a communication device. The disclosed channel switching method, channel switching apparatus, and communication device are used to select a target channel according to the interference power of multiple channels and switch the current channel to the target channel when the interference power of the current channel exceeds a preset threshold. As such, frequently switching the channel may be avoided, the stability and the robustness of the channel connection may be improved, and data transmission delay may be reduced.

In various embodiments of the present disclosure, a communication device may need to perform a clear channel assessment (CCA) before transmitting data in an unlicensed spectrum (US) band to determine whether a channel is available, so as to adaptively avoid interference with other users. The CCA may be implemented based on “listen before talk” (LBT).

The channel switching method according to various embodiments of the present disclosure may be applied to a communication device. The communication device may include a channel monitoring module. When the communication device operates using an unlicensed spectrum band, the communication device may use a channel monitoring module to temporarily suspend the sending/receiving actions at a predetermined time, and may migrate to other channels to do the monitoring and sniffing work. In one embodiment, the channel monitoring module may monitor one channel in the unlicensed spectrum band at a time and measure its interference power until the interference power of each channel included in the entire unlicensed spectrum band is measured. When the channel monitoring module constantly updates the interference power of each channel over time, the communication device can process the interference power of each channel and determine the best operating channel in the current period in real time. When LBT is triggered, the communication device can immediately migrate to the best operating channel to avoid high-frequency channel switching and high-consumption handshake overhead.

Various embodiments of the present disclosure are described in conjunction with a communication device. The communication device may include an aircraft, a handheld device, a vehicle-mounted device, a wearable device, or a computing device that has a wireless communication function, or other processing device that is connected to a wireless modem. The communication device can be called different names in different networks, for example: user equipment (UE), terminal equipment, mobile station, subscriber unit, station, cellular phone, personal digital assistant, wireless modem, wireless communication device, handheld device, laptop, cordless phone, wireless local loop station, etc. The communication device may refer to a wireless communication device or a wired communication device. The wireless communication device may be a device that provides voice and/or data connectivity to the user, a handheld device with a wireless connection function, or other processing device connected to a wireless modem, which may be able to communicate with one or more core networks via a wireless access network (such as radio access network).

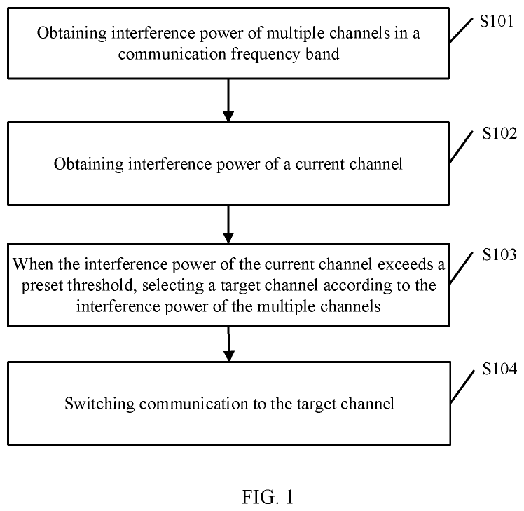

The present disclosure provides a channel switching method. FIG. 1 illustrates a schematic flowchart of an exemplary channel switching method according to various embodiments of the present disclosure. Referring to FIG. 1, the channel switching method may include the following exemplary steps.

In S101, the interference power of multiple channels in the communication band may be obtained.

In one embodiment, a second communication device may establish a communication connection with a first communication device. When operating in the communication frequency band, the second communication device may perform the CCA before sending data to the first communication device, that is, may acquire the interference power of multiple channels in the communication frequency band.

In one embodiment, the second communication device may receive the interference power of the multiple channels measured by the first communication device. The interference power of the multiple channels may be measured when the first communication device suspends transmitting data on the current channel. For example, after a communication connection is established between the second communication device and the first communication device, the first communication device may temporarily suspend data transmission on the current channel, and then measure the interference power of multiple channels through the channel monitoring module of the first communication device and send the measured interference power of the multiple channels to the second communication device. For example, the communication frequency band may include a first channel, a second channel, and a third channel with the first communication device operating on the first channel and the second communication device also operating on the first channel. The first communication device may suspend the data transmission on the first channel, measure the interference power of the second channel and the interference power of the third channel, and send the measured interference power of the second channel and the interference power of the second channel to the second communication device. In one embodiment, each time the first communication device temporarily suspends transmitting data on the first channel, the interference power of one channel may be measured. For example, when the first communication device reaches the suspension time for suspending the data transmission on the first channel, the interference power of the second channel may be measured; when the suspension time reaches (lasts) 5 ms, that is, the transmission time for transmitting data on the first channel is reached, the first communication device may transmit data on the first channel (e.g. the data transmission on the first channel may be resumed); when the transmission time reaches (lasts) 10 ms, that is, the suspension time for suspending the data transmission on the first channel is reached, the first communication device may measure the interference power of the third channel; and when the suspension time reaches (lasts) 5 ms, the first communication device may send the measured interference power of the second channel and the interference power of the third channel to the second communication device.

In one embodiment, each time the second communication device suspends transmitting data on the current channel, the interference power of one of the multiple channels may be measured until the interference power is measured for every channel of the multiple channels. For example, after a communication connection is established between the second communication device and the first communication device, the second communication device may measure the interference power of one channel through the channel monitoring module of the second communication device each time when the data transmission is suspended until the interference power of the multiple channels in the communication frequency band is measured. For example, the communication frequency band may include a first channel, a second channel, and a third channel with the second communication device operating on the first channel. When the second communication device reaches the suspension time for suspending the data transmission on the first channel, the interference power of the second channel may be measured; when the suspension time reaches (lasts) 5 ms, that is, the transmission time for transmitting data on the first channel is reached, the second communication device may transmit data on the first channel (e.g. the data transmission on the first channel may be resumed); when the transmission time reaches (lasts) 10 ms, that is, the suspension time for suspending the data transmission on the first channel is reached, the second communication device may measure the interference power of the third channel.

In one embodiment, the second communication device may temporarily suspend data transmission on the current channel, measure the interference power of one channel among the multiple channels, and receive the interference power of the other communication channels among the multiple channels measured by the first communication device when the data transmission on the current channel is suspended. As such the interference power of the multiple channels may be obtained. For example, the first communication device and the second communication device can temporarily suspend their sending/receiving actions and migrate to other channels to do the monitoring and sniffing work. Their respective channel monitoring modules can monitor one channel in the communication frequency band at a time and measure its interference power. In addition, the entire communication frequency band may be covered within a period of a preset duration (for example, 80 ms). For example, the communication frequency band may include a first channel, a second channel, and a third channel with the second communication device operating on the first channel. When the suspension time for suspending the data transmission on the first channel is reached, the second communication device may measure the interference power of the second channel, and the first communication device may measure the interference power of the third channel; when the suspension time reaches (lasts) 5 ms, that is, the transmission time for transmitting data on the first channel is reached, the first communication device may send the interference power of the third channel to the second communication device. According to the embodiments of the present disclosure, the interference power of different channels can be measured by the communication device at both ends of the communication connection, thereby improving the measurement efficiency for measuring the interference power.

In one embodiment, the time slot of the current channel may be a preset time slice in a first sub-frame, and the time slot of the target channel may be a second sub-frame, where the second sub-frame may be at least one sub-frame after the first sub-frame. For example, the first sub-frame may be an S sub-frame, and the S sub-frame may be a special sub-frame in a communication protocol that includes a GP_LBT period. The GP_LBT period may be a guard period for the CCA threshold determination. The preset time slice may be a GP_LBT period. The second sub-frame may be a downlink sub-frame immediately following the S sub-frame.

In S102, the interference power of the current channel may be obtained.

In one embodiment, the second communication device may also obtain the interference power of the current channel. The interference power of the current channel may be measured by the second communication device through the channel monitoring module, or may be sent to the second communication device by the first communication device. For example, when the second communication device operates on the first channel and reaches the suspension time for suspending the data transmission on the first channel, the second communication device may measure the interference power of the first channel. In another example, when the suspension time for the data transmission on the first channel is reached, the first communication device may measure the interference power of the first channel; when the transmission time for transmitting data on the first channel is reached, the first communication device may send the measured interference power of the first channel to the second communication device.

It should be noted that the embodiments of the present invention are not intended to limit the execution order of the exemplary steps S101 and S102. For example, the second communication device may execute the exemplary step S101 and then the exemplary step S102. In another example, the second communication device may execute the exemplary step S102 and then the exemplary step S101. In another example, the second communication device may perform the exemplary step S101 and the exemplary step S102 at the same time.

In S103, when the interference power of the current channel exceeds a preset threshold, a target channel may be selected according to the interference power of the multiple channels.

The second communication device may determine whether the interference power of the current channel exceeds a preset threshold. When the interference power of the current channel exceeds the preset threshold, the second communication device may determine that the interference on the current channel is too large to be suitable for communication, and thus may select a target channel according to the interference power of the multiple channels. In one embodiment, the preset threshold may be an idle-channel evaluation threshold.

In one embodiment, when the current channel meets a first condition, the communication device may use a channel with lower interference power as the target channel. The bandwidth of the target channel may not overlap with the bandwidth of the current channel. For example, when the reason for triggering channel switching is to stop sending data on the current channel caused by the CCA/LBT, the second communication device may select a channel with a bandwidth not overlapped with the current operating bandwidth and also having the least interference on the ground station side.

In one embodiment, when the current channel meets a second condition, the communication device may obtain the interference-power spectral density of each channel according to the interference power of the multiple channels; and use the channel with the smallest interference-power spectral density as the target channel. In other words, when the reason for triggering channel switching is that there is a channel with low interference power on the ground station side, a channel with high transmission power, or the reception performance of the current channel is degraded, the second communication device may select the channel with the minimum overall interference level on the ground station side.

In one embodiment, when data transmission on the current channel is stopped for a period longer than a preset duration, the second communication device may determine an alternative channel that meets a preset number threshold, and the time slot of the alternative channel may be a third sub-frame, and the third sub-frame may be located after the first sub-frame. When the interference power of multiple data transmitted on the alternative channel is less than or equal to a preset threshold, the second communication device may select the alternative channel as the target channel. The time slot of the target channel may be the fourth sub-frame, and the fourth sub-frame may be located after the third sub-frame. For example, the preset duration may be 10 ms, the third sub-frame may have a duration of 1024 Ts, and the fourth sub-frame may be a continuous downlink sub-frame immediately following the current data segment.

In S104, communication may be switched to the target channel.

After the second communication device selects the target channel, the second communication device may switch from the current channel to the target channel for communication, thereby avoiding frequently switching the channel due to the compliance requirements of the CCA/LBT, and quickly switching to a desired channel for communication. As such, a stable and robust channel connection may be provided for the communication device that is operating in the unlicensed frequency band.

According to the embodiments of the present disclosure, the interference power of multiple channels in the communication frequency band is obtained; the interference power of the current channel is obtained; and when the interference power of the current channel exceeds a preset threshold, a target channel is selected according to the interference power of the multiple channels; and the communication is then switched to the target channel. As such, frequently switching the channel may be avoided, the stability and the robustness of the channel connection may be improved, and data transmission delay may be reduced.

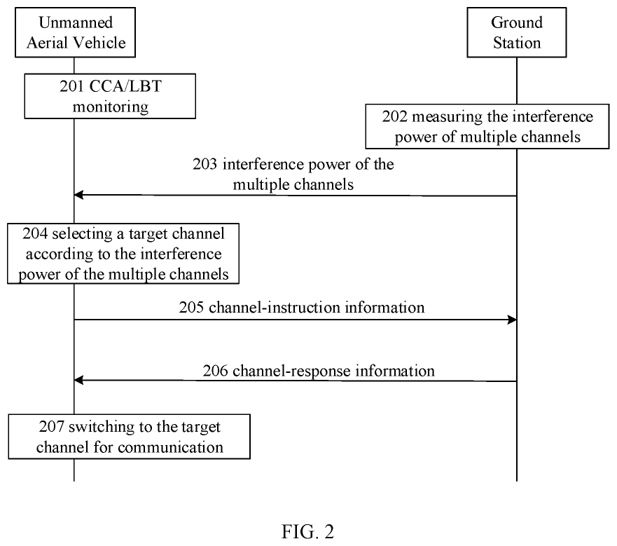

FIG. 2 illustrates a schematic flowchart of another exemplary channel switching method according to various embodiments of the present disclosure. Referring to FIG. 2, the channel switching method may include the following exemplary steps.

In S201, an unmanned aerial vehicle (UAV) may perform CCA/LBT monitoring.

In one embodiment, a UAV may be equivalent to the second communication device described in the above embodiments, and thus the UAV may perform the functions performed by the second communication device described in the above embodiments. A ground station may be equivalent to the first communication device described in the above embodiments, and thus the ground station may perform the functions performed by the first communication device described in the above embodiments.

In S201, a ground state may measure the interference power of multiple channels.

In one embodiment, a ground state may perform frequency sweep measurement. That is, the interference power of multiple channels in the communication frequency band may be measured using the channel monitoring module of a ground station.

In S203, the ground station may send the interference power of multiple channels to the UAV.

In one embodiment, the ground station may send a GND_FREQ_MEAS message to the UAV, and the GND_FREQ_MEAS message may include the interference power of multiple channels.

In S204, the UAV may select a target channel based on the interference power of the multiple channels.

In one embodiment, the criteria for selecting the target channel may be as follows. First, when the reason for triggering the selection and switching of the target channel is that the current channel is frequently blocked due to the CCA/LBT, the UAV may select a channel with a bandwidth not overlapped with the current operating bandwidth and also having the least interference on the ground station side, and use this channel as the target channel. Second, when the reason for triggering the selection and switching of the target channel is that there is a more desired channel on the ground station side or the reception performance of the current is degraded, the UAV may select the channel with the minimum overall interference level on the ground station side and use the channel as the target channel.

In S205, the UAV may send a channel instruction message to the ground station, the channel instruction message may be used to instruct the request for switching the communication to the target channel.

In one embodiment, the channel instruction message may be UAV_FREQ_SEL_INDICATION.

In S206, the UAV may receive the channel response message from the ground station, and the channel response message may be used to instruct the confirmation of the switching to the target channel for communication.

In one embodiment, the channel response information may be UAV_FREQ_SEL_CONFIRM.

In S207, the UAV may switch the communication to the target channel.

According to the various embodiments of the present disclosure, a UAV performs CCA/LBT monitoring; a ground state measures the interference power of multiple channels, and sends the interference power of the multiple channels; the UAV selects a target channel according to the interference power of the multiple channels, and sends a channel instruction message to the ground station; and the UAV receives a channel response message from the ground station, and then switches the communication to the target channel. As such, frequently switching the channel may be avoided, the stability and the robustness of the channel connection may be improved, and data transmission delay may be reduced.

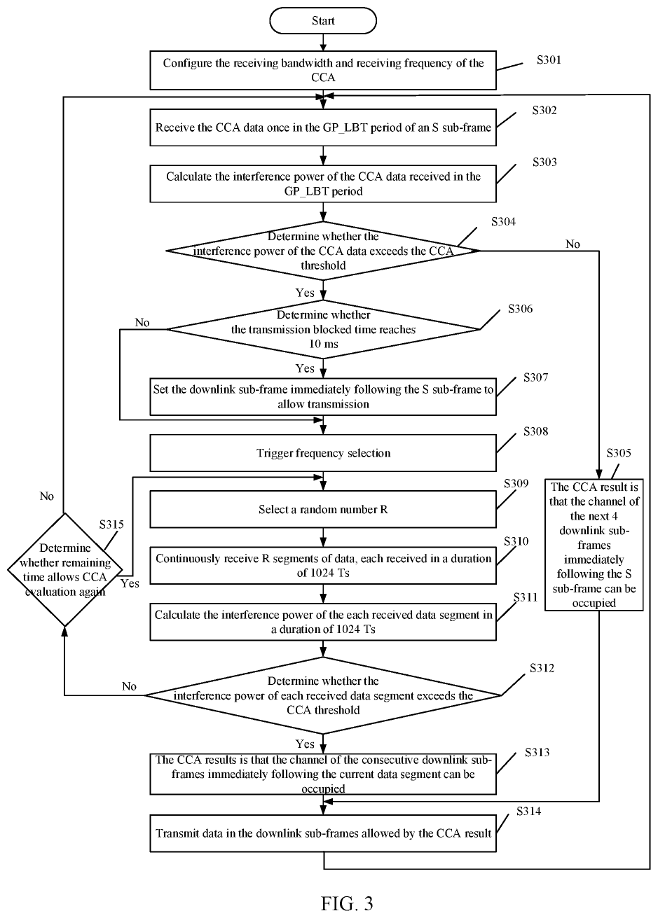

FIG. 3 illustrates a schematic flowchart of another exemplary channel switching method according to various embodiments of the present disclosure. Referring to FIG. 3, the channel switching method may include the following exemplary steps.

In S301, the receiving bandwidth and receiving frequency of the CCA may be configured.

In S302, the CCA data may be received once in the GP_LBT period of the S sub-frame.

In one embodiment, the S sub-frame may be a special sub-frame in a communication protocol, including a GP_LBT period, and the GP_LBT period may be a guard period for the CCA threshold determination.

In S303, the interference power of the CCA data received in the GP_LBT period may be calculated.

In S304, whether the interference power of the CCA data exceeds the CCA threshold may be determined.

In S305, the CCA result may be determined as that, the channel of the next four downlink sub-frames immediately following the S sub-frame can be occupied.

In one embodiment, when the interference power of the CCA data does not exceeds the CCA threshold, the CCA result may be that the channel of the next four downlink sub-frames immediately following the S sub-frame can be occupied.

In one embodiment, after the CCA result is determined as that the channel of the next four downlink sub-frames immediately following the S sub-frame can be occupied, an exemplary step S314 may be further performed.

In S306, whether the transmission blocked time reaches 10 ms may be determined.

In one embodiment, when the interference power of the CCA data exceeds the CCA threshold, whether the transmission blocked time reaches 10 ms may be determined. That is, whether the duration of the transmission being suspended reaches 10 ms may be determined.

In S307, the downlink sub-frame immediately following the S sub-frame may be set to allow transmission.

In one embodiment, when the transmission blocked time reaches 10 ms, the downlink sub-frame immediately following the S sub-frame may be set to allow transmission.

For example, when the transmission blocked time reaches 10 ms, the transmission may be forcibly transmitted within the allowable range (for example, 10%) of a duty cycle.

In one embodiment, after setting the downlink sub-frame immediately following the S sub-frame to allow transmission, an exemplary step S308 may be further performed.

In S308, frequency selection may be triggered.

In one embodiment, when the transmission blocked time does not reach 10 ms, frequency selection may be triggered. That is, when determining that the transmission blocked time does not reach 10 ms in S306, frequency selection may be directly triggered without performing the exemplary step S307.

In S309, a random number R may be selected. In one embodiment, the random number may be a natural number smaller than or equal to a predetermined value q, that is, 1≤R≤q.

In S310, R segments of data, each received in a duration of 1024 Ts, may be continuously received.

In S311, the interference power of each received data segment in a duration of 1024 Ts may be calculated.

In S312, whether the interference power of each received data segment exceeds the CCA threshold may be determined.

In S313, the CCA result may be determined as that the channel of the consecutive downlink sub-frames immediately following the current data segment can be occupied.

In one embodiment, when the interference power of each received data segment does not exceeds the CCA threshold, the CCA result may be determined as that the channel of the consecutive downlink sub-frames immediately following the current data segment can be occupied.

For example, the CCA result may be determined as that the channel of all downlink sub-frames between the end of the extended CCA evaluation and the next S sub-frame can be occupied.

In one embodiment, when the interference power of at least one segment of the received data exceeds the CCA threshold, whether the remaining time allows CCA evaluation again may be determined.

In S314, data may be transmitted in the downlink sub-frames allowed by the CCA result.

In one embodiment, after transmitting data in the downlink sub-frames allowed by the CCA result, the exemplary step S302 may be performed.

In S315, whether the remaining time allows CCA evaluation again may be determined.

In one embodiment, when the interference power of any segment of the received data exceeds the CCA threshold, whether the remaining time allows CCA evaluation again may be determined.

In one embodiment, when the remaining time allows CCA evaluation again, the exemplary step S309 may be performed; when remaining time does not allow CCA evaluation again, the exemplary step S302 may be performed.

According to the embodiments of the present disclosure, the receiving bandwidth and receiving frequency of the CCA are configured, and the CCA data is received once in the GP_LBT period of the S sub-frame. The interference power of the CCA data received in the GP_LBT period is calculated. When the interference power of the CCA data exceeds a CCA threshold, and also the transmission blocked time reaches 10 ms, the downlink sub-frame immediately following the S sub-frame is set to allow transmission. Further, frequency selection is triggered, a random number R is selected, and R segments of data, each received in a duration of 1024 Ts are consecutively received. When the interference power of each received data segment exceeds the CCA threshold, the CCA result is determined as that the consecutive downlink sub-frames immediately following the current data segment can be occupied. As such, data may be sent in the downlink sub-frames allowed by the CCA result. Therefore, frequently switching the channel may be avoided, the stability and the robustness of the channel connection may be improved, and data transmission delay may be reduced.

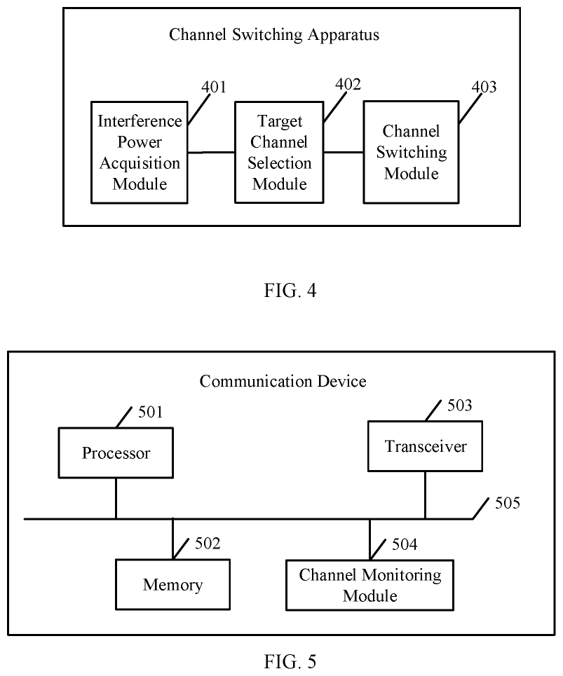

The present disclosure provides a channel switching apparatus. FIG. 4 illustrates a schematic block diagram of an exemplary channel switching apparatus according to various embodiments of the present disclosure. Referring to FIG. 4, the channel switching apparatus may include: an interference power acquisition module 401, configured to obtain interference power of multiple channels in a communication frequency band, and obtain interference power of the current channel; a target channel selection module 402, configured to select a target channel according to the interference power of the multiple channels when the interference power of the current channel exceeds a preset threshold; and a channel switching module 403, configured to switch the communication to the target channel.

In one embodiment, the preset threshold may be an idle-channel evaluation threshold.

In one embodiment, the target channel selection module 402 may be configured to: when the current channel meets a first condition, use a channel with lower interference power as the target channel, where the bandwidth of the target channel is not overlapped with the bandwidth of the current channel.

In one embodiment, the target channel selection module 402 may be configured to: when the current channel meets a second condition, obtain the interference-power spectral density of each channel according to the interference power of the multiple channels; and use the channel with the smallest interference-power spectral density as the target channel.

In one embodiment, when obtaining the interference power of the multiple channels in the communication frequency band, the interference power acquisition module 401 may be configured to: receive the interference power of the multiple channels measured by a first communication device, where the interference power of the multiple channels is measured when the first communication device suspends transmitting data on the current channel.

In one embodiment, when obtaining the interference power of the multiple channels in the communication frequency band, the interference power acquisition module 401 may be configured to: each time transmitting data on the current channel is suspended, measure the interference power of one of the multiple channels until the interference power is measured for every channel of the multiple channels.

In one embodiment, the time slot of the current channel may be a preset time slice in a first sub-frame, and the time slot of the target channel may be a second sub-frame, where the second sub-frame may be at least one sub-frame after the first sub-frame.

In one embodiment, the target channel selection module 402 may be configured to: when data transmission on the current channel is stopped for a period longer than a preset duration, determine an alternative channel that meets a preset number threshold, where the time slot of the alternative channel may be a third sub-frame, and the third sub-frame may be located after the first sub-frame; and when the interference power of multiple data transmitted on the alternative channel is less than or equal to a preset threshold, select the alternative channel as the target channel, where the time slot of the target channel may be the fourth sub-frame, and the fourth sub-frame may be located after the third sub-frame.

According to the embodiments of the present disclosure, the interference power acquisition module 401 obtains the interference power of multiple channels in the communication frequency band and also obtains the interference power of the current channel; when the interference power of the current channel exceeds a preset threshold, the target channel selection module 402 selects a target channel according to the interference power of the multiple channels; and the channel switching module 403 switches the communication to the target channel. As such, frequently switching the channel may be avoided, the stability and the robustness of the channel connection may be improved, and data transmission delay may be reduced.

The present disclosure also provides a communication device. FIG. 5 illustrates a schematic block diagram of an exemplary communication device according to various embodiments of the present disclosure. Referring to FIG. 5, the communication device may include at least one processor 501, e.g. a central processing unit (CPU); at least one memory 502; a transceiver 503; a channel monitoring module 504; and a bus 505. The at least one processor 501, the at least one memory 502, the transceiver 503, and the channel monitoring module 504 may be connected to each other through the bus 505.

The transceiver 503 may be configured to receive and send messages. The channel monitoring module 504 may be configured to monitor the interference power of each channel in the communication frequency band. The memory 502 may be configured to store program code (e.g. program instructions). The processor 501 may be configured to call the program code stored in the memory 502.

In one embodiment, when calling the program code stored in the memory 502, the processor 502 may be configured to implement the following exemplary operations: the processor 501 may acquire the interference power of multiple channels in a communication frequency band, where the interference power of the multiple channels may be obtained through the channel monitoring module 504 and/or the transceiver 503; the processor 501 may acquire the interference power of the current channel obtained through the channel monitoring module 504; when the interference power of the current channel exceeds a preset threshold, the processor 501 may select a target channel according to the interference power of the multiple channels; and the processor 501 may switch the communication to the target channel.

In one embodiment, the preset threshold may be an idle-channel evaluation threshold.

In one embodiment, the processor 501 selecting the target channel according to the interference power of the multiple channels may be that: when the current channel meets a first condition, the processor 501 uses a channel with lower interference power as the target channel, where the bandwidth of the target channel is not overlapped with the bandwidth of the current channel.

In one embodiment, the processor 501 selecting the target channel according to the interference power of the multiple channels may be that: when the current channel meets a second condition, the processor 501 obtains the interference-power spectral density of each channel according to the interference power of the multiple channels; and the processor 501 uses the channel with the smallest interference-power spectral density as the target channel.

In one embodiment, the processor 501 acquiring the interference power of the multiple channels in the communication frequency band may be that: the processor 501 receives, through the transceiver 503, the interference power of the multiple channels measured by a first communication device, where the interference power of the multiple channels is measured when the first communication device suspends transmitting data on the current channel.

In one embodiment, the processor 501 acquiring the interference power of the multiple channels in the communication frequency band may be that: each time transmitting data on the current channel is suspended, the processor 501 measures the interference power of one of the multiple channels until the interference power is measured for every channel of the multiple channels.

In one embodiment, the time slot of the current channel may be a preset time slice in a first sub-frame, and the time slot of the target channel may be a second sub-frame, where the second sub-frame may be at least one sub-frame after the first sub-frame.

In one embodiment, the processor 501 selecting the target channel according to the interference power of the multiple channels may be that: when data transmission on the current channel is stopped for a period longer than a preset duration, the processor 501 determines an alternative channel that meets a preset number threshold, where the time slot of the alternative channel may be a third sub-frame, and the third sub-frame may be located after the first sub-frame; and when the interference power of multiple data transmitted on the alternative channel is less than or equal to a preset threshold, the processor 501 selects the alternative channel as the target channel, where the time slot of the target channel may be the fourth sub-frame, and the fourth sub-frame may be located after the third sub-frame.

According to the embodiments of the present disclosure, the processor 501 acquires the interference power of multiple channels in the communication frequency band; acquires the interference power of the current channel; when the interference power of the current channel exceeds a preset threshold, selects a target channel according to the interference power of the multiple channels; and switches the communication to the target channel. As such, frequently switching the channel may be avoided, the stability and the robustness of the channel connection may be improved, and data transmission delay may be reduced.

In the above embodiments, it may be implemented in whole or in part by software, hardware, firmware, or any other combination. When implemented in software, it may be implemented in whole or in part in the form of a computer program product. The computer program product includes one or more computer instructions. When the computer program instructions are loaded and executed on a computer, the processes or functions according to the embodiments of the present disclosure are wholly or partially generated. The computer may be a general-purpose computer, a special-purpose computer, a computer network, or other programmable devices. The computer instructions may be stored in a computer-readable storage medium or transmitted from one computer-readable storage medium to another computer-readable storage medium, for example, the computer instructions may be transmitted from a web site, computer, server, or data center to another web site, computer, server or data center via a wired (such as coaxial cable, optical fiber, digital subscriber line (DSL)) or wireless (such as infrared, wireless, microwave, etc.) method. The computer-readable storage medium may be any available medium that can be accessed by a computer or a data storage device such as a server, a data center, etc. that includes one or more available medium integration. The available medium may be a magnetic medium (for example, a floppy disk, a hard disk, a magnetic tape), an optical medium (for example, a digital video disc (DVD)), or a semiconductor medium (for example, a solid state disk (SSD)), etc.

It should be noted that, under the premise of no conflict, the embodiments described in this application and/or the technical features in each embodiment can be arbitrarily combined with each other, and the technical solution obtained after the combination should also fall into the protection scope of this application.

Those of ordinary skill in the art may understand that the units and algorithm steps of each example described in combination with the embodiments disclosed herein can be implemented by electronic hardware, or a combination of computer software and electronic hardware. Whether these functions are performed in hardware or software depends on the specific application and design constraints of the technical solution. Those of ordinary skill in the art can use different methods to implement the described functions for each specific application, but such implementation should not be considered to be beyond the scope of this application.

In the various embodiments provided by the present application, it should be understood that the disclosed systems, devices, and methods may be implemented in other manners. For example, the device embodiments described above are merely illustrative. For instance, in various embodiments of the present disclosure, the units are divided or defined merely according to the logical functions of the units, and in actual applications, the units may be divided or defined in another manner. For example, multiple units or components may be combined or integrated into another system, or some features can be ignored or not executed. In addition, the mutual coupling or direct coupling or communication connection shown or discussed may be an indirect coupling or communication connection through some interface, device or unit, and may be in an electrical, mechanical, or other form.

The units described as separate components may or may not be physically separated, and the components displayed as a unit may or may not be physical in a unit, that is, they may be located in one place, or may be distributed to multiple network units. Some or all of the units may be selected according to actual needs to achieve the purpose of the solution of the embodiment.

In addition, each functional unit in each embodiment of the present application may be integrated into one processing unit, or each unit may exist physically separately, or two or more units may be integrated into one unit.

Finally, it should be noted that the above embodiments are merely illustrative of, but not intended to limit, the technical solutions of the present invention; although the present disclosure has been described in detail with reference to the above embodiments, those skilled in the art should understand that the technical solutions described in the above embodiments may be modified, or part or all of the technical features may be equivalently replaced; and the modifications or substitutions do not depart from the scope of the technical solutions of the embodiments of the present disclosure.

What is claimed is:

1. A channel switching method, comprising:
obtaining interference power of multiple channels in a communication frequency band;
obtaining interference power of a current channel;
when the interference power of the current channel exceeds a preset threshold, selecting a target channel according to the interference power of the multiple channels; and
switching to the target channel for communication.

2. The method according to claim 1, wherein:
the preset threshold is an idle-channel evaluation threshold.

3. The method according to claim 1, wherein selecting the target channel according to the interference power of the multiple channels includes:
when the current channel is in a first condition, using a channel with lower interference power as the target channel, wherein a bandwidth of the target channel is un-overlapped with a bandwidth of the current channel.

4. The method according to claim 1, wherein selecting the target channel according to the interference power of the multiple channels includes:
when the current channel is in a second condition, obtaining an interference-power spectral density of each channel according to the interference power of the multiple channels; and
using a channel with a smallest interference-power spectral density as the target channel.

5. The method according to claim 1, wherein obtaining the interference power of the multiple channels in the communication frequency band includes:
receiving the interference power of the multiple channels measured by a first communication device, wherein the interference power of the multiple channels is measured when the first communication device suspends transmitting data on the current channel.

6. The method according to claim 1, wherein obtaining the interference power of the multiple channels in the communication frequency band includes:
each time transmitting data on the current channel is suspended, measuring interference power of one channel of the multiple channels until the interference power is measured for every channel of the multiple channels.

7. The method according to claim 1, wherein:
a time slot of the current channel is a preset time slice in a first sub-frame; and
a time slot of the target channel is a second sub-frame, wherein:
the second sub-frame is at least one sub-frame after the first sub-frame.

8. The method according to claim 1, wherein:
a time slot of the current channel is a preset time slice in a first sub-frame; and
selecting the target channel according to the interference power of the multiple channels includes:
when data transmission on the current channel is stopped for a period longer than a preset duration, determining an alternative channel that meets a preset number threshold, wherein a time slot of the alternative channel is a third sub-frame, and the third sub-frame is located after the first sub-frame; and
when interference power of multiple data transmitted on the alternative channel is less than or equal to a preset threshold, selecting the alternative channel as the target channel, wherein a time slot of the target channel is a fourth sub-frame, and the fourth sub-frame is located after the third sub-frame.

9. A channel switching apparatus, comprising:
a memory, configured to store program code; and
a processor, coupled to the memory and when the program code being executed, configured to:
obtain interference power of multiple channels in a communication frequency band and obtain interference power of a current channel;
select a target channel according to the interference power of the multiple channels when the interference power of the current channel exceeds a preset threshold; and
switch to the target channel for communication.

10. The apparatus according to claim 9, wherein:
the preset threshold is an idle-channel evaluation threshold.

11. The apparatus according to claim 9, wherein the processor is further configured to:
when the current channel is in a first condition, use a channel with lower interference power as the target channel, wherein a bandwidth of the target channel is un-overlapped with a bandwidth of the current channel.

12. The apparatus according to claim 9, wherein the processor is further configured to:
when the current channel is in a second condition, obtain an interference-power spectral density of each channel according to the interference power of the multiple channels; and
use a channel with a smallest interference-power spectral density as the target channel.

13. The apparatus according to claim 9, wherein the processor is further configured to:
receive the interference power of the multiple channels measured by a first communication device, wherein the interference power of the multiple channels is measured when the first communication device suspends transmitting data on the current channel.

14. The apparatus according to claim 9, wherein the processor is further configured to:
each time transmitting data on the current channel is suspended, measure interference power of one channel of the multiple channels until the interference power is measured for every channel of the multiple channels.

15. The apparatus according to claim 9, wherein:
a time slot of the current channel is a preset time slice in a first sub-frame; and
a time slot of the target channel is a second sub-frame, wherein:
the second sub-frame is at least one sub-frame after the first sub-frame.

16. The apparatus according to claim 9, wherein:
a time slot of the current channel is a preset time slice in a first sub-frame;
the processor is further configured to:
when data transmission on the current channel is stopped for a period longer than a preset duration, determine an alternative channel that meets a preset number threshold, wherein a time slot of the alternative channel is a third sub-frame, and the third sub-frame is located after the first sub-frame; and
when interference power of multiple data transmitted on the alternative channel is less than or equal to a preset threshold, select the alternative channel as the target channel, wherein a time slot of the target channel is a fourth sub-frame, and the fourth sub-frame is located after the third sub-frame.

17. A communication device, comprising:
a transceiver;
a memory, configured to store executable program code; and
a processor, configured to call the executable program code stored in the memory, wherein:
the processor, the transceiver, and the memory are connected through a bus; and
the processor calls the executable program code stored in the memory to implement a channel switching method, including:
obtaining interference power of multiple channels in a communication frequency band;
obtaining interference power of a current channel;
when the interference power of the current channel exceeds a preset threshold, selecting a target channel according to the interference power of the multiple channels; and
switching to the target channel for communication.
